(19) United States
(12) Patent Application Publication
(10) Pub. No.: US 2018/0065876 A1
(43) Pub. Date: Mar. 8, 2018

(54) ANAEROBIC DIGESTER APPARATUS WITH A FLOATING MIXER SYSTEM INTEGRATED WITH A COVER

(71) Applicant: Thomas H. Probst, Waukesha, WI (US)

(72) Inventor: Thomas H. Probst, Waukesha, WI (US)

(21) Appl. No.: 15/812,877

(22) Filed: Nov. 14, 2017

Related U.S. Application Data
(63) Continuation of application No. 13/775,892, filed on Feb. 25, 2013, now abandoned.
(60) Provisional application No. 61/639,380, filed on Apr. 27, 2012.

(51) Int. Cl. C02F 3/28

(52) U.S. Cl. CPC C02F 3/2866; Y02E 50/343; C02F 3/2873

(57) ABSTRACT

An anaerobic digester apparatus including a container and an integrated cover and mixer system. The container includes vertical or sloped walls and is configured to contain wastewater and waste material. An integrated cover and mixer system is configured to extend over and cover the surface of the wastewater in the container. The cover is maintained on the surface of the wastewater in the container by a plurality of floats coupled to the cover. A mixer float is coupled to the cover with the mixer float including a mixer motor having a shaft extending through the mixer float and in fluid communication with the wastewater. The shaft includes an impeller configured to provide a downdraft mixing motion of the water and waste. The cover and mixer system are effectively integrated and coupled to the container to facilitate an anaerobic digestion of the waste in the container.

### CROSS-REFERENCE TO RELATED PATENT APPLICATIONS

This patent application is a continuation of U.S. patent application Ser. No. 13/775,892, filed Feb. 25, 2013, which is now pending, which claims the benefit of U.S. Provisional Patent Application No. 61/639,380, filed on Apr. 27, 2012, the entire teachings and disclosure of which are incorporated herein by reference thereto.

### BACKGROUND OF THE INVENTION

### Field of the Invention

The present invention relates generally to the field of treatment of wastewater, and more particularly to an integrated cover and mixer system for a containment of an anaerobic digester process.

An increased awareness of problems with water quality, particularly those caused by the discharge of wastewater from industrial and concentrated animal feed operation (“CAFO”) sources, results in a demand for improved equipment and methods to treat wastewater prior to discharging it into a sewer, surface water, or to other destinations for effluent discharge. While such treatment systems and methods are generally not required to produce potable water, the systems are increasingly required, by law, to enhance the quality of wastewater prior to discharging it as effluent. For industrial waste and CAFO waste, this treatment process typically has to remove certain types of pollutants, such as organic contaminants, nitrogen, phosphorus, metals, and suspended solids.

One such type of wastewater treatment includes a process including an anaerobic reactor, the contents of which is completely stirred creating what may be referred to as an anaerobic activated sludge process, or is also referred to as a contact process or complete mix process, with microorganisms which are mixed in with the wastewater to be treated. As part of such treatment system, a mixing of the wastewater and microorganisms must occur during the treatment process. In some processes, an aerobic reaction takes place in the presence of oxygen. In other treatments, an anaerobic environment (reaction occurring in the absence of oxygen) is provided with waste being mixed with the anaerobic reactor liquids containing a high concentration of microorganisms (sludge or bio solids). In the anaerobic process, the mass of pollutants and, in some instances, waste bio solids or waste sludge solids is reduced during the digestion process with the solids remaining in the tank to be disposed of in an environmentally appropriate manner. The treated wastewater is separated as a fluid for disposal or further processing.

In an anaerobic digester, it is necessary to enclose the container, typically with a cover that floats on the surface or one that is supported above the wastewater contained in the digester tank. Complete mix digester tanks require mixers to circulate the contents of the tank, with the mixers typically mounted in the bottom or the side of the digester tank or through a rigid cover on the tank.

As is typical with operating equipment, the mixers require service, and it is generally necessary to drain the digester tank which is a time-consuming and expensive process in order to service or effect repair of the mixing systems. It is also known that existing digester tanks having a bottom mounted or side mounted mixers do not mix the entire content of the digester tank sufficiently but leave dead spots where some of the tank contents is not circulated thereby reducing the effectiveness of the digester system.

The apparatus of the present disclosure must be of construction which is both durable and long-lasting, and it should also require little or no maintenance to be provided by the user throughout its operating lifetime. The present apparatus can be maintained without draining the contents of the tank, nor interrupt the treatment process during maintenance, repair, or replacement of components of the apparatus.

In order to enhance the market appeal of the apparatus of the present disclosure, this should also be of inexpensive construction to thereby afford it a broad as possible market. Finally, it is also an objective that all the aforesaid advantages and objectives are achieved without incurring any substantial relative disadvantage.

The subject matter discussed in this background of the invention section should not be assumed to be prior art merely as a result of its mention in the background of the invention section. Similarly, one or more problem(s) mentioned in the background of the invention section is (are) associated with the subject matter of the background of the invention section and should not be assumed to have been previously recognized in the prior art. The subject matter in the background of the invention section merely represents different approaches, and in and of themselves may also be inventions.

### SUMMARY OF THE INVENTION

The disadvantages and limitations of the background art discussed above are overcome by the present disclosure.

With this invention, there is provided an anaerobic digester apparatus which includes a container and an integrated cover and mixer system.

The container includes one of a circular vertical wall and is configured as a cylinder. The container can also be configured as a polygon with a plurality of planer walls, i.e. vertical walls or sloped walls. The container is configured to contain wastewater and waste material.

The integrated cover and mixer system includes a downdraft mixer and a floating or suspended cover with the downdraft mixer coupled to the cover as a single integrated unit. The anaerobic digester apparatus is configured so that the integrated cover and mixer system completes the enclosure of the container to facilitate anaerobic digestion of the wastewater and waste material contained in the container.

The cover includes material configured to extend over and cover the surface of the wastewater in the container. The cover is coupled to at least one wall of the container. If the container is circular, the cover will also be of a circular configuration and of sufficient diameter and circumference to completely enclose the open top of the container for anaerobic digestion. The cover includes a plurality of floats coupled to the cover. The floats are configured to position the cover on the surface of the wastewater in the container. The floats may provide a means of directing biogas produced in the anaerobic reactor to a point of collection and removal. The floats are disposed between a portion of the cover on the wastewater surface. The cover may also include weights to assist in maintaining the cover in position on the wastewater surface and to channel precipitation which may accumulate on the cover to a point of collection and removal.

The mixer system includes a mixer float coupled to the cover. In one embodiment a cylindrical tube is coupled to the mixer float and extends through the mixer float. The cylindrical tube is disposed at the center of the mixer float and is in fluid communication with the wastewater. A mixer motor is coupled to the mixer float. The mixer motor includes a shaft extending through the mixer float into the wastewater, with the shaft coupled to a impeller configured to provide a downdraft mixing motion of the wastewater and activated sludge. If a cylindrical tube is used, the motor is coupled to the cylindrical tube and the motor shaft extends through such tube.

The cover and mixer system are effectively integrated and coupled to the container to facilitate anaerobic digestion of the contents in the container. The cover and mixer system are configured to position the mixer float at the approximate geometric center of the wastewater surface in the container of the anaerobic digester apparatus, or, on larger installations, multiple mixers may be positioned to achieve effect complete mixing of the basin contents.

In one embodiment, a foam log is coupled to the cover and firmly or loosely to the mixer float with the foam log configured to circumvent/surround the perimeter of the mixer float and assist in maintaining the position and orientation of the mixer float.

In one embodiment, a mixer integrated ring is coupled to the cover and mixer float with the mixer integrated ring configured to circumvent/surround the perimeter of the mixer float and assist in maintaining the position and orientation of the mixer float. The mixer integrated ring defines a shelf and includes a pressure/gas seal.

In another embodiment, the plurality of floats are arranged about the mixer float in a configuration of one of radial-orientation extending from the mixer float and parallel to each other between the mixer float and container wall. If the container is circular, the radial-orientation arrangement of the plurality of floats is typically used. If the container is a polygon shape, the plurality of floats are typically arranged parallel to each other between the mixer float and the container wall.

In another embodiment, each float of the plurality of floats is disposed in a pocket defined in the cover.

During the anaerobic digestion process in the anaerobic digester apparatus, various gases such as carbon dioxide and methane are produced as a by-product of the digesting process. Such gas must be removed from the anaerobic digester apparatus. A gas effluent pipe is positioned under the cover, above the surface of the waste water in the container to collect such gas. The pipe is typically positioned as high as possible in a space defined by the cover and wall of the container. The gas effluent pipe defines a plurality of holes configured to receive any gas emitted in the container. In some embodiments, a slight vacuum is applied to the gas effluent pipes to draw the gas effluent from the digester tank and remove it from the tank for further processing or discharge.

There is further provided an anaerobic digester apparatus that includes a container having one of a circular vertical wall and a plurality of planer walls. In some embodiments the planer walls are vertical and in some embodiments the planer walls are sloped. The container is configured to contain wastewater and waste material.

The mixer system includes a mixer float integrally coupled to the cover. A cylindrical tube is coupled to the mixer float and extends through the mixer float. The cylindrical tube is disposed at the center of the mixer float and is in fluid communication with the wastewater. A mixer motor is coupled to the cylindrical tube. The mixer motor includes a shaft extending through the cylindrical tube into the wastewater, with the shaft coupled to a impeller configured to provide a downdraft mixing motion of the waste and the anaerobic mixed liquor solids (bacteria and microorganisms). The cover and mixer system are effectively integrated and coupled to the container to facilitate anaerobic digestion of the contents in the container.

A gas effluent pipe is disposed below the cover in a space defined by the cover and one wall of the container above the wastewater surface. The pipe defines a plurality of holes configured to receive any gas emitted in the container.

The apparatus of the present disclosure is of a construction which is both durable and long lasting, and which will require little or no maintenance to be provided by the user throughout its operating lifetime. The present apparatus can be maintained with or without removing it from the tank, without draining the contents of the tank, nor interrupt the treatment process during maintenance, repair or replacement of components of the apparatus. Finally, all of the aforesaid advantages and objectives are achieved without incurring any substantial relative disadvantage.

### DESCRIPTION OF THE DRAWINGS

These and other advantages of the present disclosure are best understood with reference to the drawings, in which:

FIG. 1 is a side illustration of an exemplary embodiment of an integrated cover and mixer system coupled to a wall of a container of an anaerobic digester apparatus;

FIG. 2 is a detail side view of a portion of a mixer float of FIG. 1 with a foam log coupled to a cover and a mixer float of the integrated cover and mixer system illustrated in FIG. 1;

FIG. 3 is a detail side view of a portion of cover coupling to a wall of the container of the anaerobic digester illustrated in FIG. 1 including a gas effluent pipe;

FIG. 4 is a side illustration of an exemplary embodiment of an integrated cover and mixer system coupled to a wall of a container of an anaerobic digester apparatus;

FIG. 5 is a detail side view of a portion of a mixer float of FIG. 4 with a mixer integration ring coupled to a cover and a mixer float of the integrated cover and mixer system illustrated in FIG. 4;

FIG. 6 is a detail side view of a portion of cover coupling to a wall of the container of the anaerobic digester illustrated in FIG. 4 including a gas effluent pipe;

FIG. 7 is a top view illustration of the integrated cover and mixer system illustrated in FIG. 1 with a plurality of floats in a configuration position parallel to each other between the mixer float and container wall;

FIG. 8 is a top view illustration of the integrated cover and mixer system illustrated in FIG. 4 with a plurality of floats in a configuration position radial-oriented extending from the mixer float between the mixer float and container wall;

FIG. 9 is a side illustration of an exemplary embodiment of an integrated cover and mixer system with each float of a plurality of floats disposed in a pocket defined in the cover, and illustrating a down draft mixing flow of wastewater; and

FIG. 10 is a top view of an exemplary embodiment of an integrated cover and mixer system for an anaerobic digester apparatus including a plurality of floats and weights configured in a radial-orientation extending from a mixer float positioned at the center of the integral cover.

### DETAILED DESCRIPTION OF THE EXEMPLARY EMBODIMENTS

Prior to a discussion of the preferred embodiment of the present invention, it is useful to briefly discuss the previously known anaerobic digestion waste or biomass processing systems. It is known to provide a cover that is made of a rigid metal, for example steel or aluminum, and in some cases concrete construction that in addition to covering the container of wastewater also provides a solid mounting platform for a mixer. Typically the mixer is not float supported but it is supported by the cover. Gas generated by the waste processing system in the container, under the cover, can be used, in addition to mechanical means, to hold the cover above the wastewater liquid surface.

In contrast to such configurations, the present disclosure teaches a flexible material based cover which floats on the wastewater surface with a process for extracting the gases generated by the anaerobic treatment system. Such arrangement assists in holding down the cover on the wastewater surface with the gas being extracted from the container. The mixer system of the present invention floats on the wastewater surface but is integrated with the cover.

It is also known that a mixer system can be a floating system but such system does not integrate with the cover to provide a flexible gas collecting arrangement as disclosed and claimed in the present application.

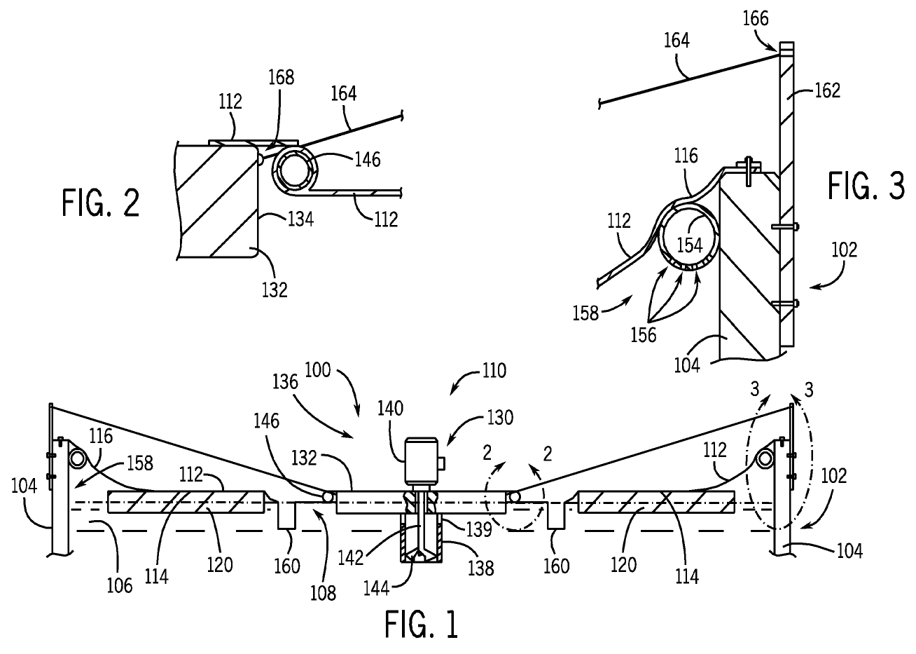

Referring now to the FIGS. 1-10, there is provided an anaerobic digester apparatus 100. The anaerobic digester apparatus 100 includes a container 102, and an integrated cover and mixer system 110. The integrated cover and mixer system 110 further includes a cover 112, and a mixer system 130.

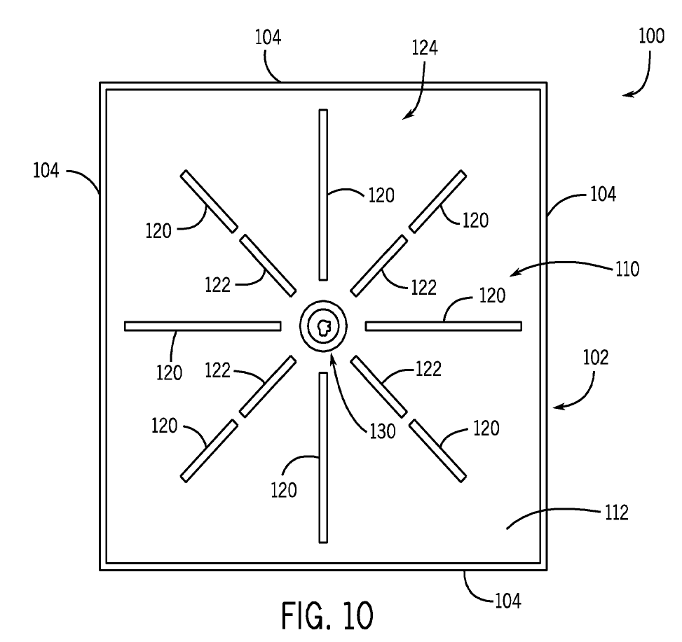

The container 102 includes a wall 104 with a container configured to contain wastewater and waste material 106. For purposes of this application, wastewater means water from agricultural or industrial processes and waste material means material suitable for anaerobic digestion and includes micro-organisms, biomass (for example vegetation), biological waste (for example manure), sludge, industrial waste or byproducts, slurries of any such material, and combinations of such material. The container can be configured as a cylinder with a single round vertical wall or a polygon shape having a plurality of planar walls. The planar walls can be configured in a vertical or sloped (angled) orientation. FIG. 10 illustrates a top view of a polygon shaped, i.e. square, container having four (4) vertical walls aligned ninety degrees to each other with the anaerobic digester integrated cover and mixer apparatus 110 covering the container 102.

An integrated cover and mixer system 110 includes a cover 112. The cover 112 is composed of a material 116 configured to extend over and cover the surface 108 of the wastewater in the container 102. The cover is coupled to at least one wall 104 of the container 102. The material 116 can be a high density polyethylene, a polyvinyl chloride, polypropylene, or other suitable gas impermeable flexible material. It is also contemplated that a semi-rigid fabric such as one produced by Siemens® identified as XR5 can also be used as determined by the manufacturer or user of the disclosed anaerobic digester apparatus 100. The disclosed integrated cover and mixer system 110 can be configured to retro-fit an existing container as determined by a user.

The cover 112 also includes a plurality of floats 118 which are coupled to the cover 112. The individual floats 120 are configured to position the cover 112 on the surface 108 of the wastewater 106 in the container 102. The floats 120 are disposed between a portion 114 of the cover and the wastewater surface 108.

The cover 112 is configured to provide a gas seal when the cover is coupled to, attached to, the walls 104 of the container 102. The cover, includes an aperture located in the center of the cover 112 with the aperture configured to receive the mixer system 130. In another embodiment, multiple apertures are configured in the cover and multiple mixers are located to best mix the contents of the container. In any case the mixer system 130 is integrally coupled to or positioned to act in an integrated mode with the cover as illustrated in FIGS. 1-6.

The mixer system 130 includes a mixer float 132 which is coupled to the cover 112. The mixer float 132 is configured to fit within the aperture defined in the cover 112 and is gas sealed to the cover. The mixer float 132 is composed of material that is suitable for use in wastewater containing waste material and is buoyant.

The mixer float 132 defines an aperture approximately in the center of the mixer float 132 and is configured to support a cylindrical tube 138 from a mounting frame 139 located intermediate the mixer float 132 and the cylindrical tube 138. The cylindrical tube 138 is coupled to the mounting frame 139 with the cylindrical tube 138 positioned somewhat below the mixer float to allow reactor liquids to enter the top of the cylindrical tube 138 through the mounting frame 139. The cylindrical tube 138 and the mounting frame 139 extend below the mixer float 132 so that both are in fluid communication with the wastewater 106, which can freely flow inwardly through the mounting frame 139 and into the top of the cylindrical tube 138. The cylindrical tube 138 is composed of material that is compatible with the mixer float 132 and the cover 112, and is suitable for exposure to the wastewater and material in the container 102.

A mixer motor 140 is coupled to the mixer float 132 by any convenient means with the mixer motor 140 including a shaft 142 extending through the mounting frame 139 and the cylindrical tube 138 into the wastewater 106. The shaft 142 is coupled to an impeller 144 which is configured to provide a downdraft mixing motion of the wastewater and waste material 106. (See FIGS. 1, 4, and 9). In another embodiment the cylindrical tube 138 is not used, but the motor shaft 142 extends from the mixer motor 140 through the mixer float 132 into the wastewater. The mixer motor 140 rotates the shaft 142 at a speed determined by the user of the anaerobic digester apparatus 100 that is suitable for the composition of the wastewater and waste material in the container 102.

Control of the mixer motor as to its speed and duration of operation can be controlled by a controller coupled to the motor and situated at a location suitable for the given circumstances. For example, the controller can be mounted to the outside of the vertical wall of the container 102 or it can be a remote controller coupled to the motor by hardwire, or a wireless, radio signal as determined by the manufacturer and/or user. The mixer motor 140 can be an AC or DC motor of suitable power rating and may include a gear train or transfer box to control the mixer operation.

The integrated cover mixer system 110 provides an effectively integrated system coupled to the container to facilitate anaerobic digestion of the waste in the container 102.

In one embodiment, a foam log 146 is coupled to the cover 112 and the mixer float 132. The foam log 146 is configured to circumvent/surround the perimeter 134 of the mixer float 132 and assist in floating the mixer system 130 in the container 102. FIGS. 1 and 2 illustrate an exemplary embodiment of the foam log 146 covered with the cover material 116 and coupled firmly or loosely to the mixer float 132.

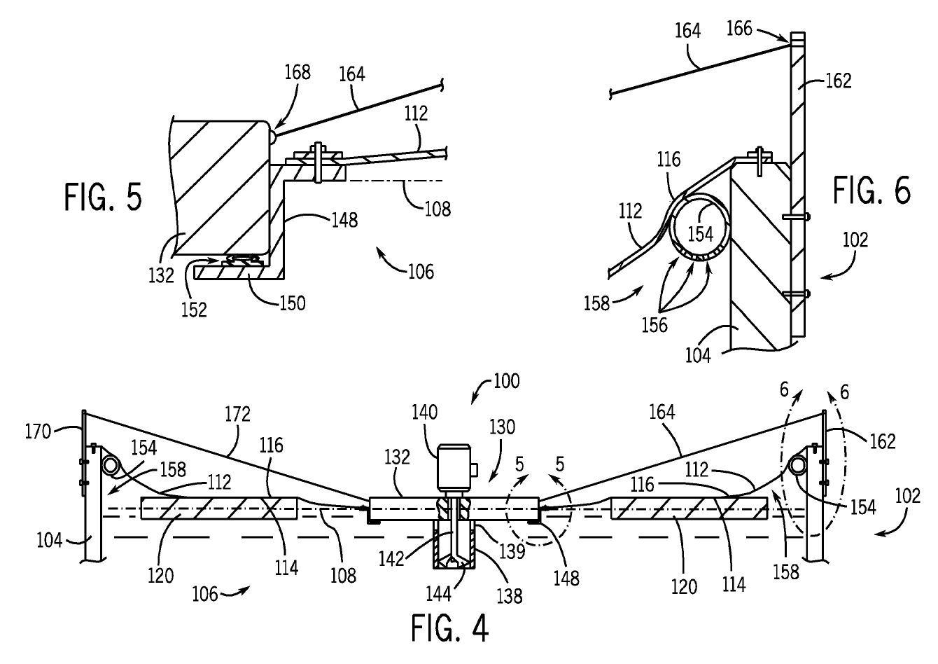

In another embodiment, the integrated cover mixer system 110 includes a mixer integration ring 148 which is coupled to the mixer float 132. See FIGS. 4 and 5. The mixer integration ring 148 is configured to circumvent/surround the perimeter 134 of the mixer float 132 and defines a shelf 150. The mixer float 132 is supported by the shelf 150 with the mixer integration ring 148 coupled to the cover 112 and configured to support the mixer float 132 on the shelf. To assist in maintaining the anaerobic digester system, a pressure/gas seal 152 can be mounted on the shelf 150 and disposed below the mixer float 132. (See FIG. 5).

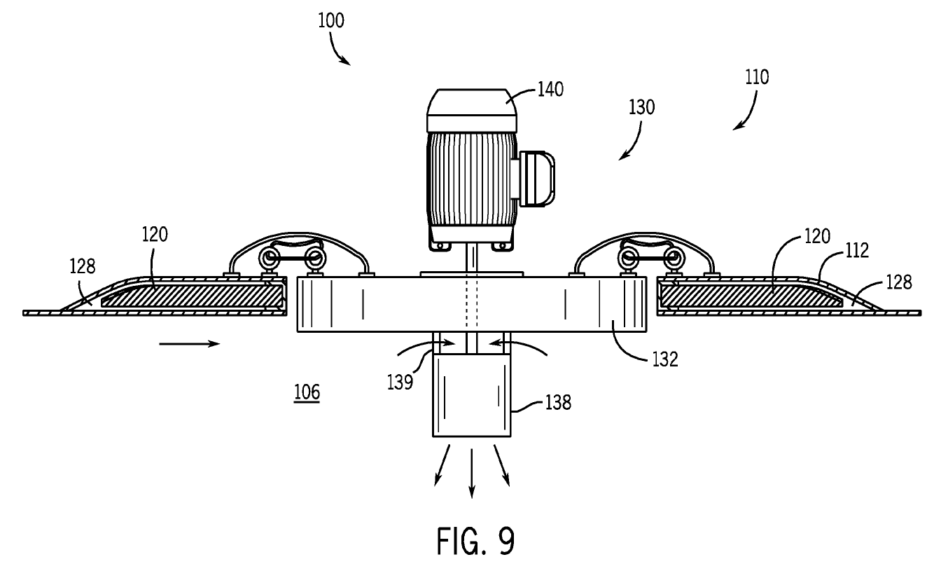

FIG. 9 illustrates an additional embodiment of coupling the mixer float 132 to the cover 112 of the integrated cover and mixer system 110.

The anaerobic digester apparatus 100 also includes a gas effluent pipe 154 that is disposed below the cover 112 in a space 158 defined by the cover 112, one wall 104 of the container 112 and the wastewater surface 108. (See FIGS. 1, 3, 4, and 6). The gas effluent pipe 154 defines a plurality of holes 156, typically in the pipe wall exposed to the wastewater surface, and is configured to receive any gas emitted in the container during the biological processes occurring in the container 102 of the anaerobic digester apparatus 100. The gas effluent pipe 154 is typically mounted in the highest reasonable location underneath the cover 112 and close to the wall 104 of the container 102. In a preferred embodiment, a slight vacuum is applied to the gas effluent pipes to draw the gas effluent from the digester tank 102. Such removal of the gas generated during the biological processes in the container 102 assist in maintaining the cover 112 in close proximity of the surface 108 of the wastewater and waste material 106.

The anaerobic digester apparatus 100 may also include a sump bucket 160 in the cover 112, with the sump bucket 160 positioned between the mixer float 132 and the container wall 104. (See FIG. 1). Such sump bucket would accumulate any external water, such as rain water which can be removed by any suitable and appropriate means such as a submersible pump or allow the water from the top of the cover 112 to drain into the reactor.

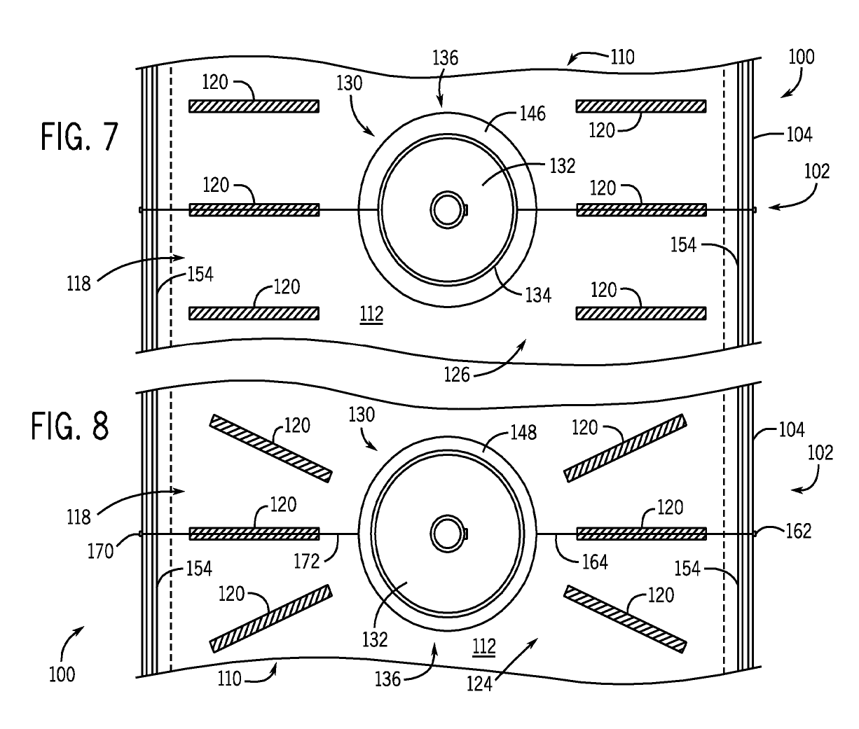

The anaerobic digester apparatus 100 has the plurality of floats 118 coupled to the cover 112. The floats reside on the surface 108 of the wastewater and waste material 106 and assist to maintain the position of the cover 112 in the container 102. In one configuration, the floats are positioned in a radial-oriented 124 arrangement extending from the mixer float 132 (See FIGS. 8 and 10). In another configuration, the plurality of floats 118 are positioned in a parallel 126 arrangement with the floats parallel to each other between the mixer float 132 and the container wall 104. (See FIG. 7).

The floats, are coupled to the cover by fasteners, for example snaps, Velcro, or suitable adhesive. The floats can also be enclosed in a pocket 128 defined in the cover 112. (See FIG. 9). The specific arrangement of the floats as to their orientation or coupling to the cover, is determined based on the intended use of the anaerobic digester apparatus 100.

In some embodiments, a weight 122 can also be coupled to the cover 112 to assist in maintaining the position of the cover 112 on the surface 108 of the wastewater 106 in the container 102 of the anaerobic digester apparatus 100. (See FIG. 10). Such use of weights, can assist in preventing the cover 112 from ballooning up and away from the surface of the wastewater in the container 102. The weights also assist to channel rain water and snow melt water into the sump bucket 160 or other collection points.

In one embodiment, the anaerobic digester apparatus includes a tether post 162 coupled to the container wall 104. One end 166 of the tether line 164 is coupled to the tether post 162 and another end 168 of the tether line 164 is coupled to the mixer float 132. See FIGS. 1-6. In another embodiment, a second tether post 170 is coupled to the container wall 104 diametrically opposite the other tether post 162 with one end 166 of a second tether line 172 coupled to the tether post 170 and the mixer float 132. Both tether lines 164,172 are configured to assist in positioning the mixer system 130 at a predetermined location 136 on the surface 108 of the wastewater 106 of the container 102. Other embodiments include three or four tether posts 162 and tether lines 164 that are positioned about the container 102 to position the mixer system 130 in a predetermined location 136. Other embodiments include multiple mixer systems 130 integrated with the cover 112 as determined by the user or manufacturer.

The preferred predetermined location of the mixer system 130 is the center of the surface of the wastewater in the container. Positioning and maintaining the mixer system 130 in a predetermined location can be used with the tether system described above or with aligning the mixer system 130 and the cover 112 for the particular geometry of the container 102 in a specific anaerobic digester apparatus 100. The exact location of the mixer system 130 is based on a modeling program which provide adequate mixing for biological processes of the wastewater and waste material 106 in the container 102. It is also contemplated that more than one mixer system 130 may be included in the integrated cover and mixer system 110 if appropriate, for example the container 102 is large enough to accommodate two or more mixer systems in one integrated cover and mixer system.

For purposes of this disclosure, the term “coupled” means the joining of two components (electrical or mechanical) directly or indirectly to one another or the concurrent use of the two components. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of the present mechanism has been shown and described with reference to particular embodiments and applications thereof, it has been presented for purposes of illustration and description and is not intended to be exhaustive or to limit the disclosure to the particular embodiments and applications disclosed. It will be apparent to those having ordinary skill in the art that a number of changes, modifications, variations, or alterations to the mechanism as described herein may be made, none of which depart from the spirit or scope of the present disclosure. The particular embodiments and applications were chosen and described to provide the best illustration of the principles of the mechanism and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be claimed alone or in combination with any of the features, elements, or components of any of the other embodiments discussed above.

What is claimed is:

1. An anaerobic digester apparatus comprising:
a container including one of a circular vertical wall and a plurality of planar walls, the container configured to contain wastewater and waste material; and
an integrated cover and mixer system, with the cover comprising:
a material configured to extend over and cover the surface of the wastewater in the container, with the cover coupled to at least one wall of the container; and
a plurality of floats coupled to the cover, with the floats configured to position the cover on the surface of the wastewater in the container; and
with the mixer system comprising:
a mixer float fixed to the cover and in contact with the wastewater such that movement of the mixer float with the wastewater results in movement of the cover; and
a mixer motor coupled to the mixer float, the mixer motor including a shaft extending through the mixer float into the wastewater, with the shaft coupled to an impeller configured to provide a down draft mixing motion of the wastewater and waste material.

2. The anaerobic digester apparatus of claim 1, wherein the planar walls are configured in one of a vertical orientation and a sloped orientation.

3. The anaerobic digester apparatus of claim 1, further comprising a flotation device coupled to the cover and mixer float, with the flotation device configured to circumvent/surround the perimeter of the mixer float.

4. The anaerobic digester apparatus of claim 3, wherein the floatation device is one of a foam log and a plurality of discrete floats coupled together.

5. The anaerobic digester apparatus of claim 1, further comprising a mixer integration ring defining a shelf with the mixer integration ring coupled to the cover and configured to support the mixer float on the shelf.

6. The anaerobic digester apparatus of claim 5, including a pressure seal mounted on the shelf and disposed below the mixer float.

7. The anaerobic digester apparatus of claim 1, further comprising:
a cylindrical tube coupled to the mixer float and extending below the mixer float, with the cylindrical tube disposed at the center of the mixer float and in fluid communication with the wastewater, with the mixer motor coupled to a shaft extending through the float and into the cylindrical tube and into the waste water.

8. The anaerobic digester apparatus of claim 1, a gas effluent pipe disposed below the cover in a space defined by the cover and one wall of the container above the wastewater surface, with the pipe defining a plurality of holes configured to receive any gas emitted in the container.

9. The anaerobic digester apparatus of claim 1, including a sump bucket defined in the cover, with the sump bucket positioned between the mixer float and the container wall.

10. The anaerobic digester apparatus of claim 1, with the plurality of floats arranged about the mixer float in a configuration of one of radial-orientation extending from the mixer float and parallel to each other between the mixer float and container wall.

11. The anaerobic digester apparatus of claim 1, with each float of the plurality of floats disposed in a pocket defined in the cover.

12. The anaerobic digester apparatus of claim 1, further comprising a tether post coupled to the container wall with one end of a tether line coupled to the tether post and another end coupled to the mixer float.

13. The anaerobic digester apparatus of claim 12, including at least one additional tether post coupled to the container wall opposite the other tether post with one end of a second tether line coupled to the tether post and the mixer float, with both tether lines configured to position the mixer system at a predetermined location on the surface of the wastewater in the container.

14. The anaerobic digester apparatus of claim 13, wherein the predetermined location is the center of the surface of the wastewater in the container.

15. The anaerobic digester apparatus of claim 1, further comprising at least one additional mixer system coupled to and integrated with the cover a spaced distance from the other mixer system.

16. An anaerobic digester apparatus including a container having one of a circular vertical wall and a plurality of planar walls, the container configured to contain wastewater and waste material the anaerobic digester apparatus comprising:
an integrated cover and mixer system, with the cover comprising:
a material configured to extend over and cover the surface of the wastewater in the container, with the cover coupled to at least one wall of the container; and
a plurality of floats coupled to the cover, with the floats configured to position the cover on the surface of the wastewater in the container; and with the floats disposed between a portion of the cover and the wastewater surface; and
with the mixer system comprising:
a mixer float coupled to the cover by one of a direct connection of the cover to the mixer float or by a mixer integration ring wherein the cover is attached to the mixer integration ring and wherein the mixer integration ring has a shelf which supports a surface of the mixer float which faces the wastewater;
a cylindrical tube coupled to the mixer float and extending below the mixer float, with the cylindrical tube disposed at the center of the mixer float and in fluid communication with the wastewater; and
a mixer motor coupled to a shaft extending through the float and into the cylindrical tube into the wastewater, with the shaft coupled to an impeller configured to provide a down draft mixing motion of the wastewater and waste; and
a gas effluent pipe disposed below the cover in a space defined by the cover and one wall of the container above the wastewater surface, with the pipe defining a plurality of holes configured to receive any gas emitted in the container.

17. The anaerobic digester apparatus of claim 16, wherein the planar walls are configured in one of a vertical orientation and a sloped orientation.

18. The anaerobic digester apparatus of claim 16, further comprising a flotation device coupled to the cover and mixer float, with the flotation device configured to circumvent/surround the perimeter of the mixer float.

19. The anaerobic digester apparatus of claim 18, wherein the flotation device is one of a foam log and a plurality of discrete floats coupled together.

20. The anaerobic digester apparatus of claim 16, including a pressure seal mounted on the shelf and disposed below the mixer float.

21. The anaerobic digester apparatus of claim 16, including a sump bucket defined in the cover, with the sump bucket positioned between the mixer float and the container wall.

22. The anaerobic digester apparatus of claim 16, with the plurality of floats arranged about the mixer float in a configuration of one of radial-orientation extending from the mixer float and parallel to each other between the mixer float and container wall.

23. The anaerobic digester apparatus of claim 16, with each float of the plurality of floats disposed in a pocket defined in the cover.

24. The anaerobic digester apparatus of claim 16, further comprising at least one additional mixer system coupled to and integrated with the cover a spaced distance from the other mixer system.

25. The anaerobic digester apparatus of claim 16, further comprising a tether post coupled to the container wall with one end of a tether line coupled to the tether post and another end coupled to the mixer float.

26. The anaerobic digester apparatus of claim 25, including at least one additional tether post coupled to the container wall diametrically opposite the other tether post with one end of a second tether line coupled to the tether post and the mixer float, with both tether lines configured to position the mixer system at a predetermined location on the surface of the wastewater in the container.

27. The anaerobic digester apparatus of claim 26, wherein the predetermined location is the center of the surface of the wastewater in the container.
